(19) United States
(12) Patent Application Publication
(10) Pub. No.: US 2009/0167033 A1
(43) Pub. Date: Jul. 2, 2009

(54) ELECTROMAGNETIC DEVICE FOR GENERATING ELECTRICAL CURRENT AND METHODS THEREOF

(76) Inventor: Uri Rapoport, Moshav Ben Shemen (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/304,524

(22) PCT Filed: Jun. 11, 2007
(86) PCT No.: PCT/IL07/00703

§ 371 Date: Dec. 12, 2008

Related U.S. Application Data
(60) Provisional application No. 60/812,615, filed on Jun. 12, 2006.

(51) Int. Cl. F03G 7/08; H02K 35/02

(52) U.S. Cl. 290/1 R; 310/15

(57) ABSTRACT

The present invention discloses an electromagnetic electrical current generator (EECG) which comprises a hollow outer envelope having a side wall with a predetermined magnetic polarity distributed over its inner surface, one inner core free to move in said envelope characterized by the same magnetic polarity distributed over its outer surface, one conducting wire located in or on the outer envelope adapted to generate AC current, and a diode bridge interconnected to said conducting wire adapted to transform said AC current to DC current. A method for providing an EECG for generating electrical current is also disclosed.

### FIELD OF THE INVENTION

The present invention generally relates to an electromagnetic device for generating electrical current and methods thereof.

### BACKGROUND OF THE INVENTION

A homopolar generator, also known as a unipolar generator, acyclic generator, or disk dynamo, is an electrical generator in which the magnetic field has the same polarity at every point, so that the armature passes through the magnetic field lines of force continually in the same direction. The device is electrically symmetrical, and generates continuous current. Some of these devices also have “homopolar magnets”, which have pole pieces arranged around a common centre. These devices are generally very inefficient and are not used as a practical power source, but it showed the possibility of generating electric power using magnetism, and led the way for commutated direct current dynamos and then alternating current dynamos.

One of the earliest patents on the general type of homopolar generators was attained by Charles E. Ball (U.S. Pat. No. 238,631; March 1881). Other early patents for homopolar generators were awarded to S. Z. De Ferranti and C. Batchelor separately. Nikola Tesla was interested in the Faraday disc and conducted work with homopolar generators. He eventually patented an improved version of the device and his U.S. Pat. No. 406,968 (“Dynamo Electric Machine”) describes an arrangement of two parallel discs on separate, parallel axles, and joined like pulleys by a metallic belt. This would have greatly reduced the frictional losses caused by sliding contacts. Later, patents were awarded to C. P. Steinmetz and E. Thomson for their work with homopolar generators. The Forbes dynamo, developed by the Scottish electrical engineer George Forbes, was in widespread use during the beginning of the 20th century. Much of the development done in homopolar generators was patented by J. E. Noeggerath and R. Eickemeyer.

Parker Kinetic Designs have produced devices which can produce five mega-amperes. Another large homopolar generator was built by Sir Mark Oliphant at the Research School of Physical Sciences and Engineering, Australian National University. It produced 500 mega-joules and was used as an extremely high-current source for experimentation from 1962. It was disassembled in 1986. Oliphant's construction was capable of supplying currents of up to 2 mega-amperes.

U.S. Pat. No. 6,351,049 discloses a magnetic bearing for centering a first body, which is mobile in tilting, relative to a second body includes: a hollow outer part at least part of which is made from a ferromagnetic material and which is attached to the first body and which has an inside surface whose shape is a portion of a sphere, an inner part which is attached to the second body and which includes two separate members which are separated by a space and which each include a plurality of (at least three) ferromagnetic areas which are offset angularly about the reference axis, which each define in conjunction with the inside surface of the hollow outer part two air-gaps offset relative to the reference axis and which are each provided with a specific winding adapted to generate magnetic flux lines closing across the two air-gaps, and an excitation circuit for selectively applying excitation currents to the windings.

Nowadays, most of the electrical generators are configured with a shaft, which increases the friction forces and lowers the generator electrical power.

As an example, RU patent 2,177,201 discloses an electric motor based on permanent magnets having non-magnetic frame, two permanent magnets coming in the form of balls each being put on shaft fitted with drive for its turn. Permanent magnets are positioned inside frame on its opposite ends.

None of these prior art references disclose an electromagnetic device for generating current in this present configuration and a method thereof.

### SUMMARY OF THE INVENTION

It is thus one object of the present invention to provide an efficient electromagnetic electrical current generator (EECG) comprising: an hollow outer envelope (200) having side wall (201) with a predetermined magnetic polarity distributed over its inner surface; at least one inner core (100), free to move in said envelope (200) characterized by the same magnetic polarity distributed over its outer surface; at least one conducting wire (300) located in or on the outer envelope adapted to generate AC current; and, a diode bridge interconnected to said conducting wire (300) adapted to transform said AC current to DC current.

It is also in the scope of the present invention wherein the outer envelope and the inner core are spheres or cylinders.

It is also in the scope of the present invention wherein the inner surface of said outer envelope (200), and the outer surface of said inner core (100) are at least partially covered, doped, immersed, impregnated, soaked, coated, painted or otherwise disposed by an effective measure of magnets disk shaped or in a powder form comprising the same.

It is also in the scope of the present invention wherein the inner core is a piston.

It is also in the scope of the present invention wherein said predetermined magnetic polarity is North polarity.

It is also in the scope of the present invention wherein said predetermined magnetic polarity is South polarity.

It is also in the scope of the present invention wherein said inner core has a non-uniform mass, increasing the erratic movement of said inner core.

It is also in the scope of the present invention wherein generator comprises two or more cores.

It is still in the scope of the present invention wherein said inner core is an assembly of a plurality of magnets designing any shape with a single predetermined polarity, especially a pyramid.

It is also in the scope of the present invention to provide a method for providing an electromagnetic device for generating electrical current comprising: giving said outer envelope a measurable acceleration or velocity, so as said inner core is actuating back and forth; hence inducing a variation of the magnetic flux density, and producing electrical current until the accelerating or actuating of the outer envelope stops.

It is also in the scope of the present invention wherein the method comprises incorporating a weight in the bottom of said inner core to increase the erratic movement of the same.

It is also in the scope of the present invention wherein the method comprises providing an assembly of a plurality of magnets designing any suitable shape, with a single predetermined magnetic polarity especially a pyramid.

While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### BRIEF DESCRIPTION OF THE FIGURES

In order to understand the invention and to see how it may be implemented in practice, and by way of non-limiting example only, with reference to the accompanying drawing, in which

FIG. 1 is partial perspective view of the inner and outer balls without the magnetic elements of the present invention;

FIG. 2 is a cross section of the inner and outer balls showing the distribution of the magnet elements;

FIG. 3 is a cross section of the side wall of the outer ball showing the distribution of the magnet elements;

FIG. 4 is a partial perspective view of the inner and outer balls with the conductor wires;

FIG. 5 is a partial perspective view of the inner and outer balls showing the distribution of south polarity of the magnet elements (south type);

FIG. 6 is a partial perspective view of the inner and outer balls showing the distribution of north polarity of the magnet elements (north type);

FIG. 7 is a partial perspective view of the pyramid-shaped inner and outer objects; and

FIG. 8 is a partial perspective view of the inner and outer objects cylinder-shaped.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide an electromagnetic device for generating electrical current and a method thereof.

The term ‘conductor wire’ refers in the present invention to any electromagnetic wire elongated strand of drawn metal that may be optionally looped to create an electronic inductor or electromagnet.

The term ‘diode bridge’ refers in the present invention to any arrangement of four diodes connected in a bridge circuit that provides the same polarity of output voltage for any polarity of the input voltage. It is used for conversion of alternating current (AC) input into direct current (DC) output.

The term ‘current’ refers in the present invention to direct electric current and/or alternating electric current.

The term ‘alternating current’ refers in the present invention to an electrical current whose magnitude and direction vary with nonuniform rate not-exclusively a sine wave.

The term ‘erratic’ refers in the present invention to the simultaneous rotational and linear motion of the inner core.

The term ‘plurality’ applies hereinafter to any integer greater than or equal to one.

Faraday's law of induction gives the relation between the rate of change of the magnetic flux through the surface S enclosed by a contour C and the electric field along the contour. This law (in its modern form) states that an electric current is induced in a closed electrical circuit when the magnetic flux enclosed by the circuit changes (in either magnitude or direction).

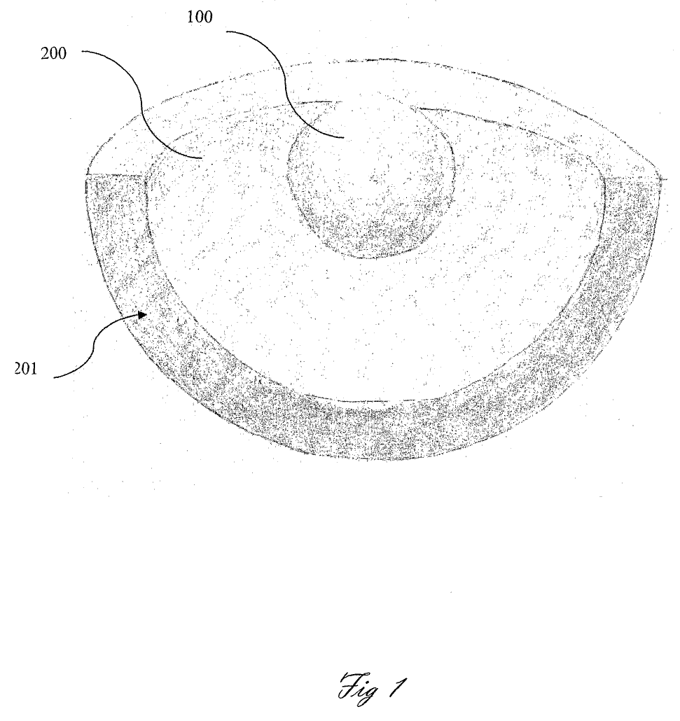

Reference is made now to FIG. 1, presenting a partial perspective view of the inner ball (100) and outer ball (200) which constitute the device of the present invention. The two balls are preferably formed of a plastic material of any desired type. The outer ball is hollow and has a side wall (201). On the inner surface of said outer ball (200) and on the outer surface of said inner ball (100) disk-shaped magnets of the same predetermined polarity (north-type or south-type) cover the surfaces. If the two balls are brought close enough together, their fields will begin to interact: the balls will repel one another. The inner ball will orient itself in the center of the hollow outer ball, because of its repulsion to the north or south magnetic poles of the outer ball. The inner ball is therefore a freely suspended magnet.

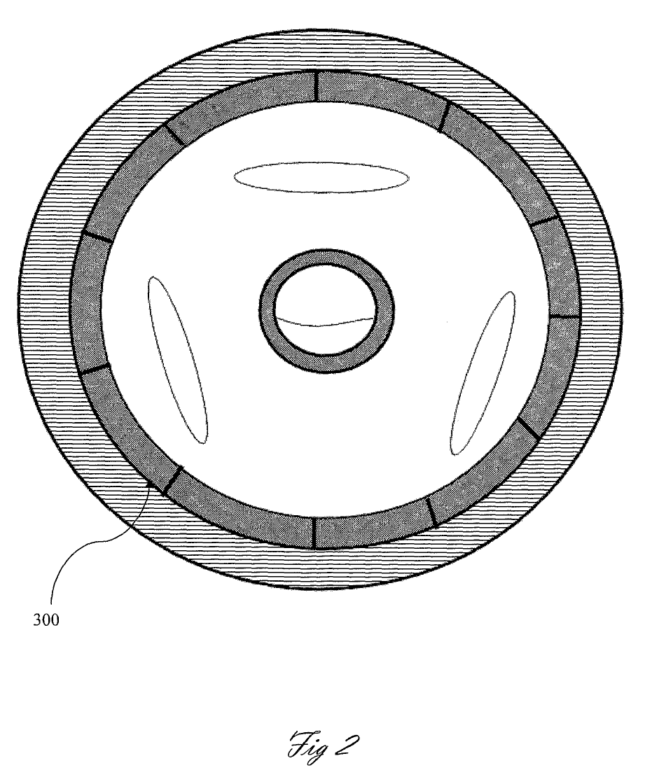

Reference is made now to FIG. 2, presenting a cross section of the inner and outer balls showing the distribution of the magnet elements. The magnetic field is represented by the flux lines. Three conductor wires, placed between the two magnets are also represented in FIG. 2. When given an initial push to the outer ball, the inner ball will move back and forth, inducing a variation of the magnetic field causing a production of electricity until the push on the outer ball stop, the inner ball will replace itself in the center of the outer ball. The variation of the magnetic flux density produces an electromotive force (E.M.F), which is a measure of the strength of a source of electrical energy and is measured in volts. The conductor wire located in the changing magnetic filed generate an alternating current.

According to one embodiment of the present invention the inner ball may have a non-uniform mass and acts as a pendulum. Once moved off its resting position, as a simple gravity pendulum the inner ball executes erratic movement, resulting form the varying attraction-repulsion forces that are continually varying. The additional mass increases the inertia and the non-symmetrical feature of the magnetic field. The movement of the inner ball will be simultaneously rotational, because of the non-uniformity of the mass, and linear, because of the attraction and repulsion forces between said inner ball and the inner side walls of the outer ball.

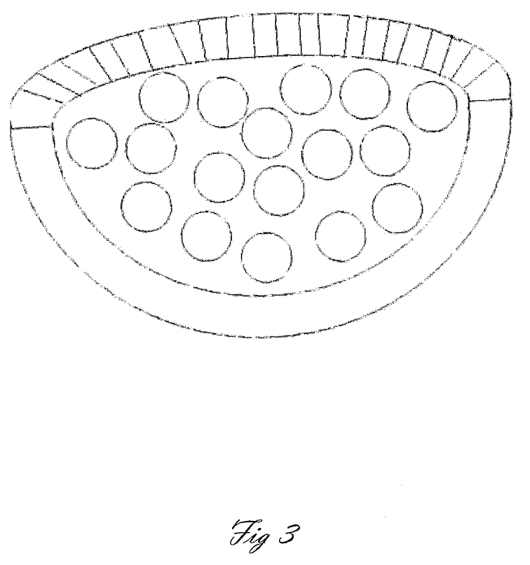

Reference is made now to FIG. 3, presenting a cross section of the side wall of the outer ball showing the distribution of the magnet elements of north-type.

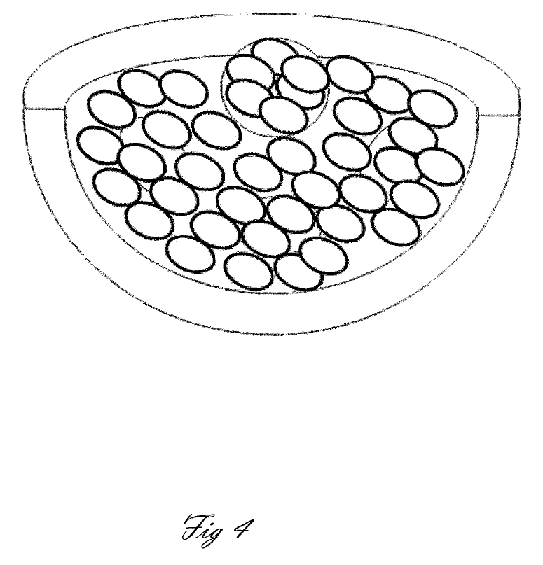

Reference is made now to FIG. 4, presenting a partial perspective view of the inner and outer balls with the three conductor wires.

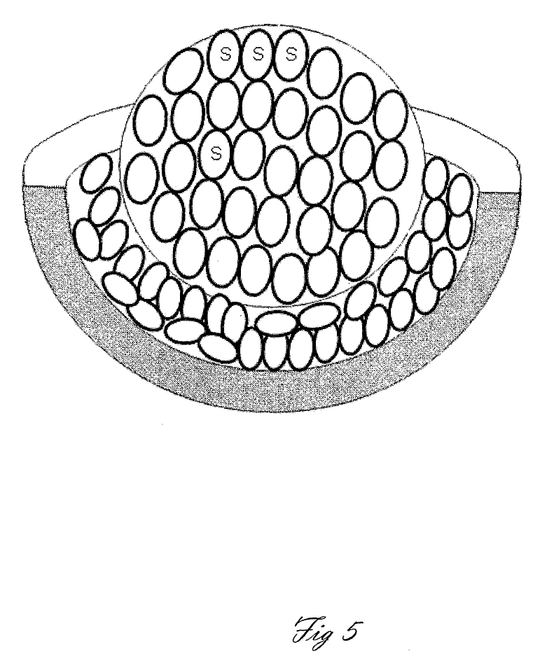

Reference is made now to FIG. 5, presenting a partial perspective view of the inner and outer balls showing the distribution of south polarity of the magnet elements (south type).

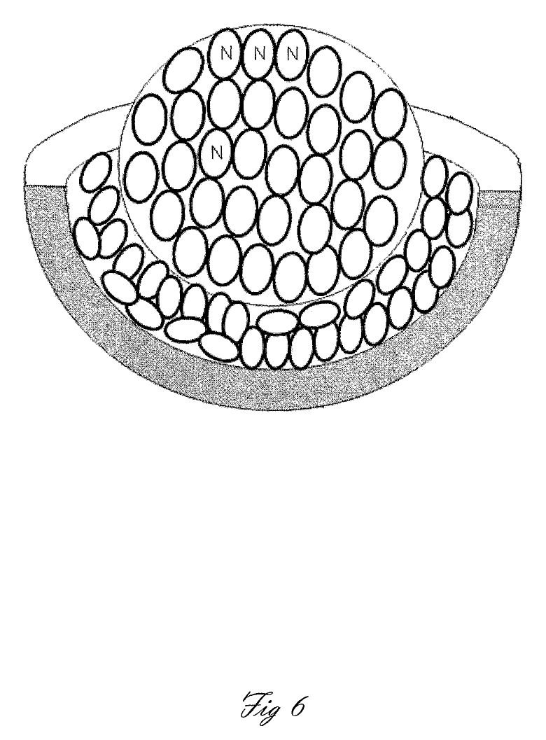

Reference is made now to FIG. 6, presenting a partial perspective view of the inner and outer balls showing the distribution of north polarity of the magnet elements (north type).

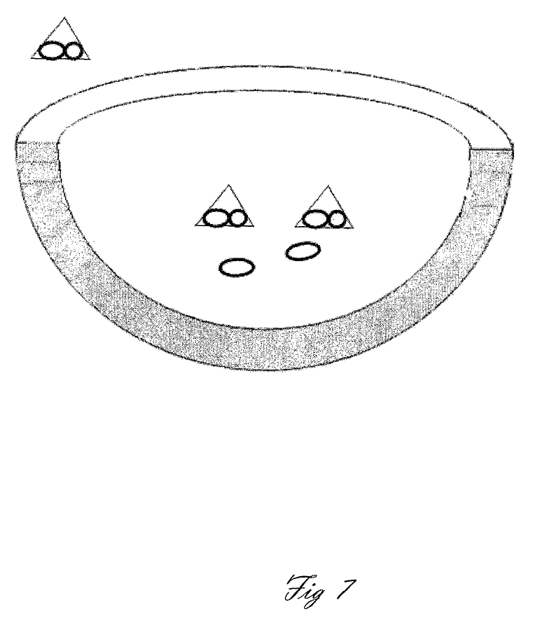

Reference is made now to FIG. 7, presenting a partial perspective view of a plurality of pyramid-shaped inner ball.

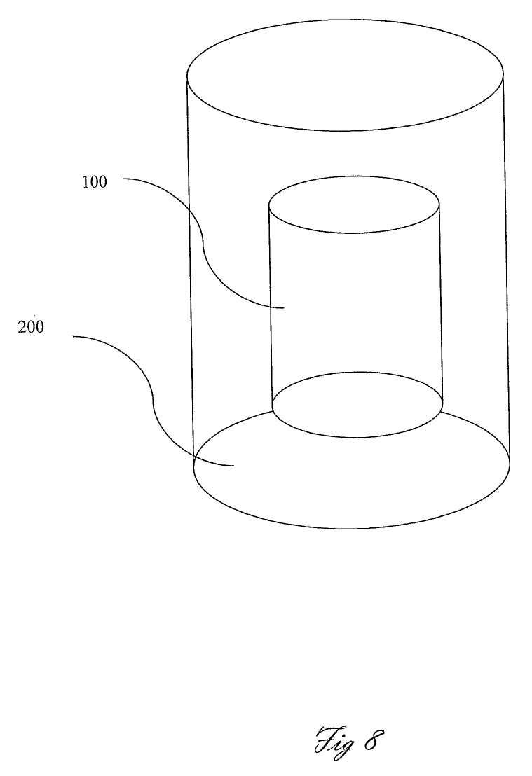

Reference is made now to FIG. 8, presenting a partial perspective view of the inner and outer objects cylinder-shaped.

### EXAMPLES

Various examples were carried out to prove the embodiments claimed in the present invention. Some of these experiments are referred hereinafter. The examples describe the manner and process of the present invention and set forth the best mode contemplated by the inventors for carrying out the invention, but are not to be construed as limiting the invention.

The ball generator may be incorporated in a floating body, and be adapted to utilize wave motion of, for example, the sea. The wave movements which are almost always present in varying intensities are used, together with known induction principles, to obtain or generate electric power. Sea wave motion can cause relative movement between the induction elements to generate electricity. The ball generator can also be incorporated in a buoy which can be attached to boat.

The ball generator can be utilized in several storage processes for military uses, for example.

The ball generator may also be incorporated in a watch, and be adapted to utilize for example the human arm motion.

1. An electromagnetic electrical current generator (EECG), comprising;
a. an hollow outer envelope (200) having side wall (201) with a predetermined magnetic polarity distributed over its inner surface;
b. at least one inner core (100), free to move in said envelope (200) characterized by the same magnetic polarity distributed over its outer surface;
c. at least one conducting wire (300) located in or on the outer envelope adapted to generate AC current; and,
d. a diode bridge interconnected to said conducting wire (300) adapted to transform said AC current to DC current.

2. The EECG according to claim 1, wherein said outer envelope and said inner core are spheres or cylinders.

3. The EECG according to claim 1, wherein the inner surface of said outer envelope (200), and the outer surface of said inner core (100) are at least partially covered, doped, immersed, impregnated, soaked, coated, painted or otherwise disposed by an effective measure of magnets.

4. The EECG according to claim 3, wherein said magnets are disk shaped.

5. The EECG according to claim 3, wherein said magnets are in a powder form.

6. The EECG according to claim 1, wherein said inner core is a piston.

7. The EECG according to claim 1, wherein said predetermined magnetic polarity is North polarity.

8. The EECG according to claim 1, wherein said predetermined magnetic polarity is South polarity.

9. The EECG according to claim 1, wherein said inner core has a non-uniform mass, increasing the erratic movement of said inner core.

10. The EECG according to claim 1, comprises two or more cores (100).

11. The EECG according to claim 1, wherein said inner core is an assembly of a plurality of magnets designing any shape with a single predetermined polarity, especially a pyramid.

12. A method for providing an EECG for generating electrical current, comprising;
a. giving said outer envelope a measurable acceleration or velocity, so as said inner core actuates back and forth; hence
b. inducing a variation of the magnetic flux density, and producing electrical current until the accelerating or actuating of the outer envelope stops.

13. A method according to claim 12, further comprising incorporating a weight in the bottom of said inner core to increase the erratic movement of the same.

14. A method according to claim 12, further comprising providing an assembly of a plurality of magnets designing any suitable shape, with a single predetermined magnetic polarity, especially a pyramid.
